(19) United States
(12) Patent Application Publication
(10) Pub. No.: US 2011/0142049 A1
(43) Pub. Date: Jun. 16, 2011

(54) MEDIA OVER IP PERFORMANCE ENHANCEMENT

(76) Inventor: William Paul Harding-Jones, Shackleford (GB)

(21) Appl. No.: 12/965,355

(22) Filed: Dec. 10, 2010

(30) Foreign Application Priority Data
Dec. 10, 2009 (GB) GB 0921668.0

(51) Int. Cl. H04L 12/56

(52) U.S. Cl. 370/392

(57) ABSTRACT

A method of transmitting data traffic from a network node comprising the steps of identifying a plurality of data packets as being members of a data session adding a timestamp to the header or data payload of each packet within the session wherein the timestamp is an additional timestamp and transmitting the packets to their destination.

### CLAIM OF FOREIGN PRIORITY

The present application claims the benefit and foreign priority under 35 U.S.C. 119 from Great Britain patent application No. GB 0921668.0, filed Dec. 10, 2009, the entire contents of which are hereby incorporated by reference as if fully set forth herein.

### FIELD

This invention relates to enhancing the performance of media traffic over the Internet Protocol. It is particularly suitable, but by no means limited, to implementation as a realtime transport protocol (RTP) performance enhancing proxy for an IP (internet protocol) router carrying VoIP (Voice over IP) traffic.

### BACKGROUND

Within the digital network systems of today, and in particular the often congested telephony infrastructure of the public switched telephone network (PSTN), it is becoming increasingly popular to route voice communications over the internet, specifically, that is to use VoIP. This is particularly useful when there is no PSTN infrastructure at either the originator or the recipient of a voice communication, such as in a less developed country or a remote location, or where a dedicated network is to be set up for a specific purpose, for example for reasons of data security and integrity. In this event, it is often desired to use a dedicated satellite network.

Typically, RTP is used for the transfer of audio and video data across an IP network. In general, IP networks suffer from occurrences of network outage, congestion and varying network delays which influence the latency experienced by packets of data travelling across the network. In turn, this may affect the quality of the voice delivered to the recipient as the packets must be recombined at the receiver. If certain packets have been corrupted, lost, or delayed, the packets available for recombination may be insufficient such that, for a given bandwidth, the packets available for recombination cannot provide an acceptable quality level of voice communication.

In particular, satellite networks tend to suffer from large latency. Packet switched satellite networks also suffer large variations in data packet delay, also known as data packet jitter.

RTP has a built-in jitter compensation capability, but implementations are not always capable of buffering for the amount of jitter experienced in large latency networks such as satellite networks. Typically, RTP implementations struggle to accommodate jitter of hundreds of milliseconds. This larger jitter that is often present in packet switched satellite networks is manifested as a perceived drop in the audio quality of the transmitted conversation due to insufficient packets being available for recombination at the receiver.

Therefore, a common problem with media traffic, in particular when traversing a network comprising a satellite link, is the perceived quality of the transmitted voice, which greatly affects quality and user satisfaction, and the network bandwidth required in order to provide sufficient packets at the receiver in order to achieve an acceptable level of quality of the transmitted voice. In addition, it is often the case that the terminal device, such as a VoIP telephone, negotiates its codec bandwidth without knowledge of the network capacity.

It would therefore be beneficial to provide a performance enhancement for an IP router, especially such a router deployed to carry media traffic over satellite networks, that enables the router to cope with a transmission network that experiences low bandwidth or high jitter/latency network conditions such as those often present in satellite networks. Media traffic such as VoIP packets on the network could be optimised for both network bandwidth efficiency and the perceived quality of the recombined digital audio or other data contained within the data packets traversing the network may also be maintained.

### SUMMARY

The invention is as set out in the Claims.

By adding an additional timestamp to data packets that have been identified as members of a data session, jitter compensation can be performed such that the packets may be re-constituted at the same time and frequency as they arrived at the transmission router and in the correct sequence. The perceived quality of audio transmitted within these packets once reconstituted at the recipient can be maintained.

By removing requests for non-required codecs, such as codecs with a high-bandwidth requirement, the data traffic requires less bandwidth, and also by identifying packets containing silence and removing those packets from the data session, the data packets may be transmitted in a more efficient manner.

By identifying and removing replicated data from the header of a data packet, the bandwidth requirement of transmitting those packets can be reduced.

Any or all of these techniques can be used in combination such that both bandwidth may be reduced and quality levels may be maintained in an IP network carrying media data traffic over IP.

### BRIEF DESCRIPTION OF THE DRAWINGS

Embodiments will now be described, by way of example only, and with reference to the drawings in which:

FIG. 1A illustrates an overview of a typical IP network;

FIG. 1B illustrates a typical LAN to WAN network;

FIG. 2 illustrates a data path through an IP router according to the invention for LAN to WAN IP routed data;

FIG. 3 illustrates the data path of FIG. 2 with an additional RTP Performance Enhancing Proxy Stage;

FIG. 4 illustrates a data path through an IP router according to the invention for WAN to LAN IP routed data;

FIG. 5 illustrates the data path of FIG. 4 with an additional RTP Performance Enhancing Proxy Stage;

FIG. 6A shows a flow diagram according to the invention at a conversation originating LAN; and

FIG. 6B shows a flow diagram according to the invention at a recipient LAN.

In the figures, like elements are indicated by like reference numerals throughout.

### DETAILED DESCRIPTION

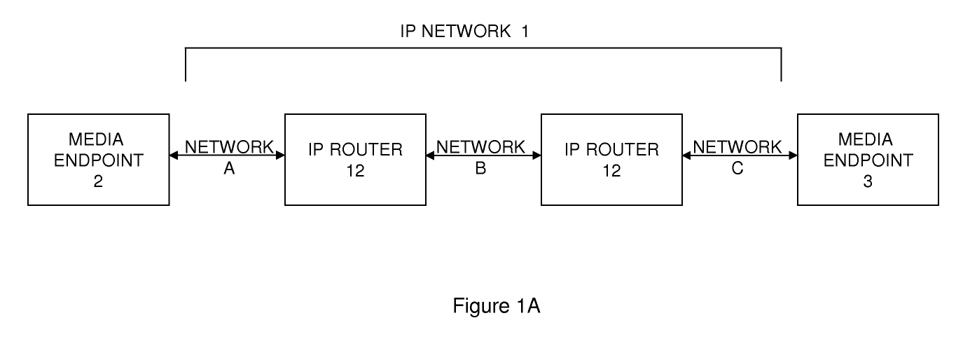

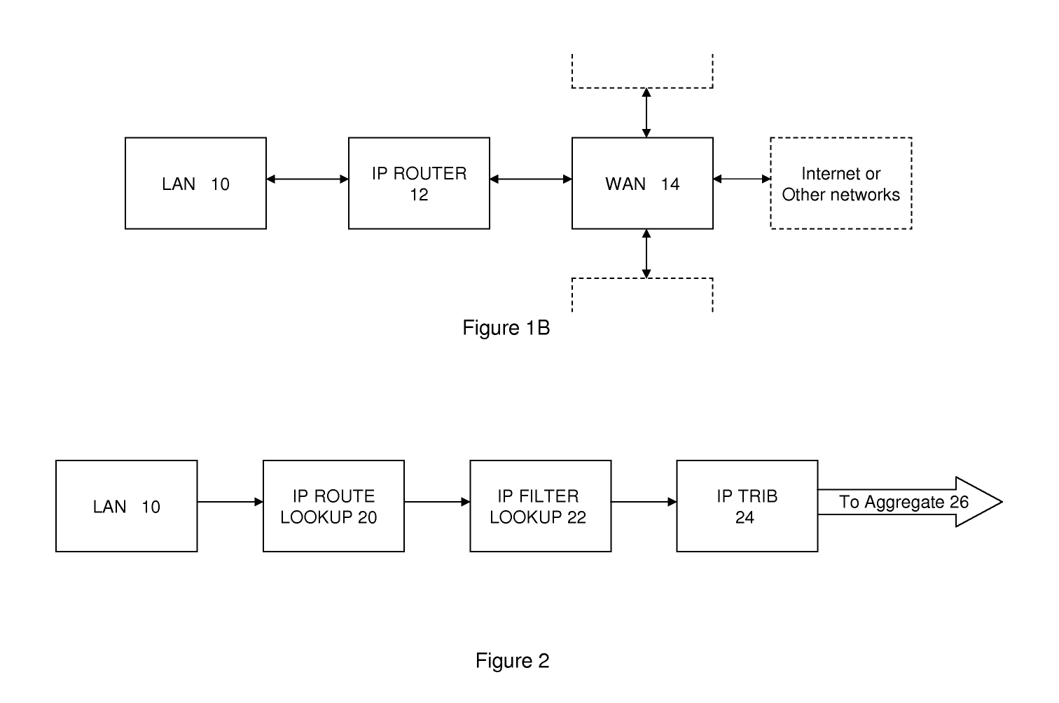

By way of overview, and as is illustrated in FIGS. 1A and 1B, two media devices 2, 3 communicate over an IP network 1. The IP network comprises, for example, Networks A, B and C. Typically, Networks A and C comprise relatively high bandwidth/low jitter networks such as LANs 10 and 11 of FIGS. 1B and 2 to 5. Network B (such as WAN 14 of FIG. 1B) would typically comprise a low bandwidth/high jitter network, for example a satellite network. Network B is, in effect, an impaired network that imposes capacity and quality constraints upon the data traffic it carries.

As shown in FIG. 1B, local area network (LAN) 10 is coupled via an IP router 12 to a wide area network (WAN) 14 and the internet. Multiple LANs may be connected together in this manner.

A point-to-point or pseudo point-to-point link (known as an aggregate) is initiated to join LANs across a network such as that of FIG. 1. This network may involve the use of satellite transmission. Specific data packet traffic may be routed across an aggregate via a dedicated point-to-point data tunnel (known as a tributary). Tributaries can be multiplexed across aggregates from LAN to LAN via the IP routers and the WAN. In its simplest form, a tributary is a point-to-point tunnel endpoint for transferring packets between the LANs over the intermediate WAN.

As discussed in more detail below, a standard embedded IP router, such as IP Router 12 in a multiplexer platform is equipped with a performance enhancing proxy for VoIP traffic, which, when enabled, gives an enhanced RTP gateway to the WAN 14. More specifically, the processing of IP tributary data undergoes the additional steps of:
Header compression for RTP traffic
Session Initiation Protocol (SIP) filtering, such as SDP (Session Description Protocol) 64 kbit/s codec filtering
Jitter buffering for RTP traffic
Filtering out of certain small samples in G729B codec (a speech coding algorithm providing audio data compression)

Packets that will traverse any one tributary in a particular direction and that are identified, at an originating IP router, as a session such as a conversation, are compressed, filtered and buffered according to the above. Corresponding data manipulation is performed at the recipient IP router for subsequent recombination into a standard RTP form. This technique can allow a reduction in the bandwidth requirement for their successful transmission at an acceptable level of quality, and compensate for the network jitter experienced. Data packet delivery can be guaranteed over the aggregate by way of sequencing, (that is identifying the position of a packet in a sequence) and hence identifying missing packets from the sequence, and also by the use of checksums to identify packet errors. Packets containing errors, for example those caused by corruption or significant delay in the network, may be discarded.

Hence the quality of VoIP conversations across networks such as satellite networks with, for example, large jitter, can be maintained, and the bandwidth requirement to tunnel these conversations across an IP network may be reduced.

By utilising the above additional steps in combination with the awareness of conversation context within the multiplexer platform, the jitter buffering can additionally utilise a small proportion (by adding a small timestamp to each voice data packet) of the significant bandwidth savings achieved by the other three steps. As a result of the additional timestamp, the quality of an RTP stream can be preserved across bandwidth-sensitive networks which suffer from large variations in latency (packet-to-packet delays) by providing additional jitter compensation as described in more detail below.

This technique achieves concurrent low bandwidth usage and high perceived quality. As will be described below, individual controls are provided over each of the above elements such that bandwidth and perceived quality of the transmission may be controlled when it is implemented across a network such as a satellite network.

Turning to FIG. 2, a data path through an IP router 12 according to the invention for LAN to WAN IP routed data within a network of FIG. 1 is illustrated. An aggregate point to point link 26 provides a data path from LAN 10 to WAN 14 to a destination LAN such as LAN 11 of FIG. 4. The IP routed data utilises a tributary tunnel path 24 for point to point data transmission. The tributary data tunnel path used for VoIP RTP data transfer is selected via IP Route 20 and an IP Filter 22 lookup tables. The IP Route Lookup 20 selects a tributary for the LAN interface to forward a packet over via a destination IP address lookup in the IP route table. The IP Filter Lookup 22 can redirect or discard traffic based on other IP traffic attributes, for example redirecting all RTP and SIP traffic down a specific tributary.

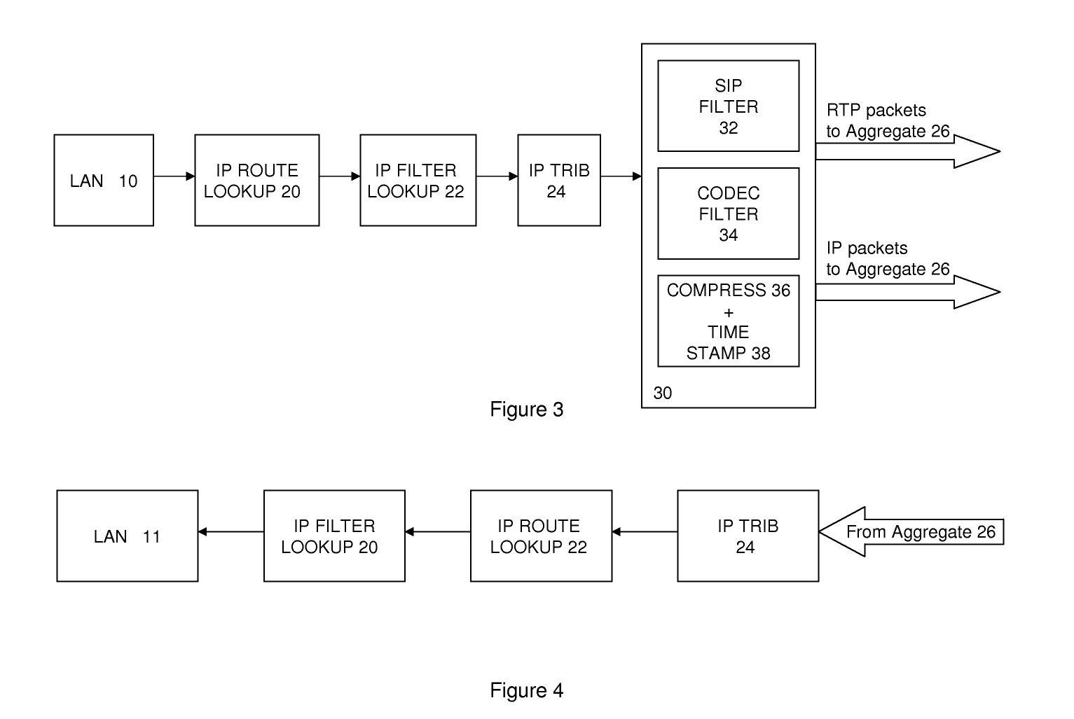

With the performance enhancing proxy in operation, and hence the enhanced RTP gateway enabled, an additional RTP Performance Enhancing Proxy (PEP) stage 30 is performed on the SIP and RTP packets before transmission of these packets over the tributary tunnel path 26 as shown in FIG. 3.

Within the RTP PEP stage 30, the three steps of SIP filtering 32, codec filtering 34, and RTP header compression 36 are executed with an optional fourth step 38 of adding an additional timestamp to the RTP.

SIP filtering at filter stage 32 comprises stripping out any negotiation messages in the SIP session description protocol messages which request the high-bandwidth codecs such as the 64 kbit/s G.711 codecs, and forcing the audio terminals to use the much less bandwidth intensive 8 kbit/s G.729 codec instead.

Codec filter stage 34 then filters out small-sample packets which occur in G.729B when transitioning into and out of silence suppression mode. During “normal” conversations, it can be seen that some G729B devices generate smaller samples (of 10 ms) as voice/silence transitions occur. These are silence information descriptors used for comfort-noise generation during silent periods. In realworld listening trials, these packets have not been found to substantially enhance or improve the perceived voice quality. By deleting these packets, bandwidth may be saved.

Compression stage 36 comprises stripping out the constant portion of the headers of each RTP packet resulting in less header data being transmitted and hence a reduction in the required bandwidth for transmission of the RTP packet.

Timestamp stage 38 comprises adding a timestamp to each RTP voice packet. This timestamp, an additional timestamp to the standard RTP timestamp, is added to the data payload of each RTP packet and is used as a means of timing the release of the packet into the remote recipient IP network, for example LAN 11, once the packet has traversed the impaired network. This additional timestamp enables the RTP jitter buffer mechanism to operate for all RTP data streams, since the standard RTP timestamp implementation varies according to the media stream carried. Thus, jitter caused by a high variation of latency in a network link is removed from the voice data packets. A smooth and predictable feed of voice packets is thereby provided to the remote voice terminal, for example in LAN 11. This substantially improves the overall perceived voice quality of the conversation and due to the bandwidth savings achieved by the other three steps, even after the addition of the timestamp, the bandwidth is still reduced overall from that required by a network link not operating with the features described herein.

It will be appreciated that all, one or a sub-combination of these stages can be implemented as appropriate.

FIG. 4 shows the data path through an IP router for WAN to LAN IP routed data from a network such as FIG. 1. Typically, the arrangement of FIG. 4 would provide the recipient part of the aggregate link 26 of FIG. 2. Aggregate point to point link 26 provides the data path from WAN 14 to LAN 11. The IP routed data utilises the same tributary tunnel path 24 for the point to point data transmission. The reverse process of IP Filter 22 and IP Route 20 lookup tables is used at the recipient end of aggregate link 26.

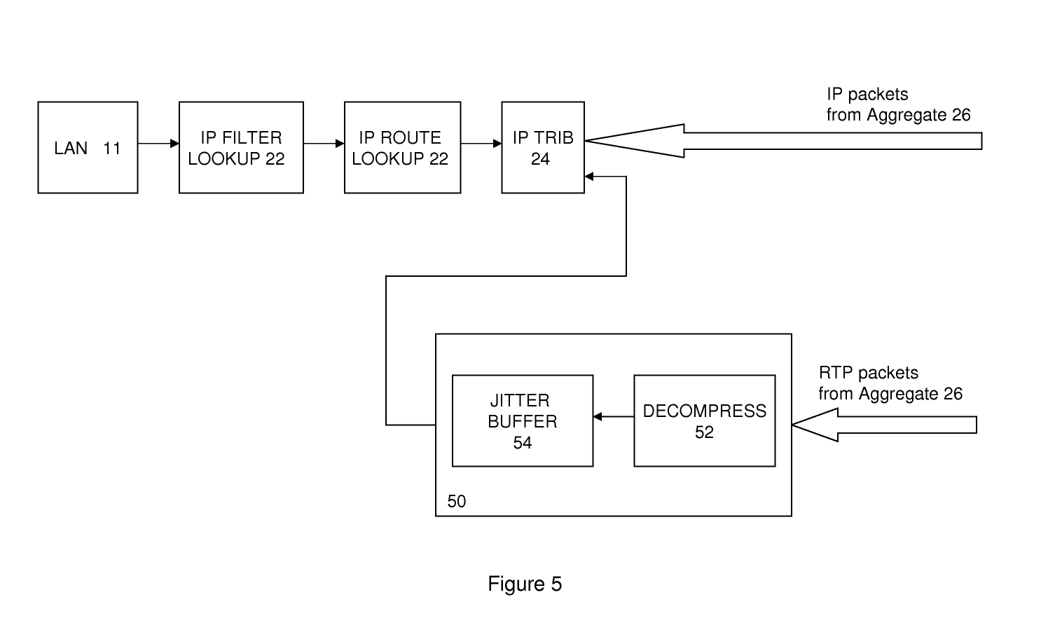

When the performance enhancing proxy server is in operation, and hence the enhanced RTP gateway is enabled, an additional RTP PEP stage 50 is performed on the RTP packets as they are received at the endpoint of the tributary tunnel 24 before being routed to the LAN 11 as shown in FIG. 5.

Decompression stage 52 comprises restoring the constant data that was stripped out of the header before transmission such that the original packets are reconstituted at the recipient. This enables standard network infrastructure to deal with the packets once they have arrived at the destination endpoint of tributary 24. If a timestamp was added during RTP PEP stage 30, the timestamp is used in conjunction with a jitter buffer 54 to time the release of the RTP packets into recipient LAN 11 and hence provide the packets to the recipient at the correct time and same frequency and order that they arrived at the transmission router.

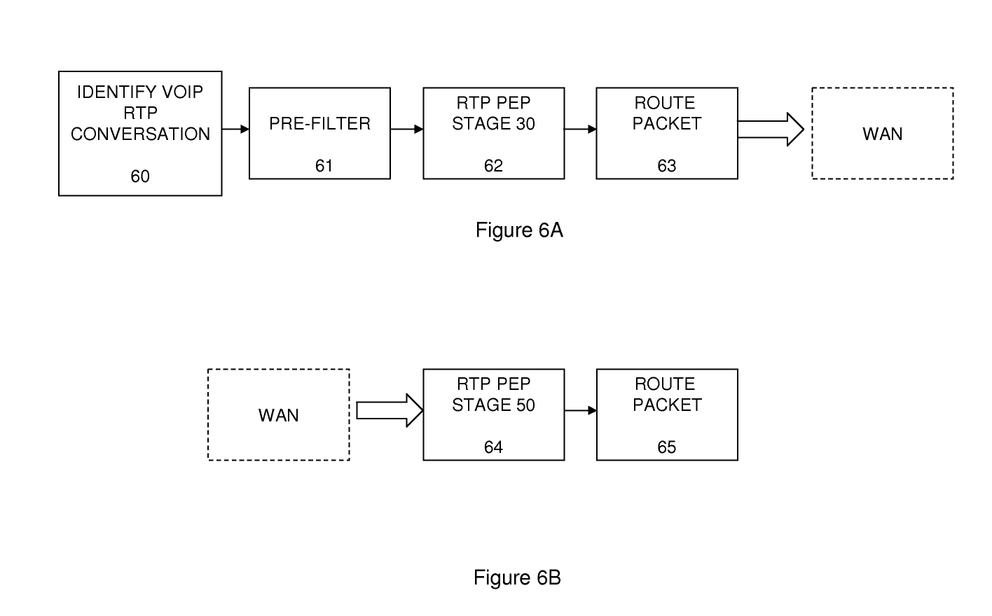

In operation, as shown in FIG. 6A, at step 60, a VoIP RTP conversation originates and is identified in a LAN, such as LAN 10. Pre-filtering such that only RTP & SIP UDP traffic is sent across tributary link 24 is carried out at step 61. In step 61, protocol headers are interrogated to identify RTP and SIP packets.

When the RTP packets reach RTP PEP stage 30 (at step 62), the RTP PEP filtering mechanism on tributary 24 is carried out as shown in the following pseudo-code. Reference numerals from the figures are provided in the code.

```
If valid UDP packet
{
  If even port number (RTP packets are even port numbers)
  {
    If SIP packet [SIP filter stage 32]
      Do SIP filtering
    Else
    {
      If (G729BShortPacketFiltering)
      [Codec Filter stage 34]
      {
        If (G729 RTP packet AND length is less than 40bytes)
          DiscardPacketAndReturn
      }
      RTPCompressPacket [Compress stage 36]
    }
  }
}
ForwardAcrossTribAsStandardIPTraffic [Route Packet step 63]
```

SIP packets are filtered as described in more detail in relation to SIP filter stage 32, and all other packets are codec filtered by stage 34 and compressed by stage 36.

If any data is stripped from a packet, the checksums are recalculated before the data is sent on across the aggregate as a standard IP routed packet at stage 63.

When RTP data is identified in PEP stage 30, a new transport header is used to carry this data across the tributary 24. The transport header (see table 1 below) identifies the data as RTP PEP data, i.e. the data has been dealt with by RTP PEP stage 30 and includes a conversation identifier that allows up to 255 RTP conversations to be conveyed across each tributary link 24. The header length for all the new RTP PEP headers is only 2 bytes.

TABLE 1

| | Bits | | |
|---|---|---|---|
| | 4 | 4 | 8 |
| Use | Type | HeaderLength | Conversation Id |

The Type identification code used across IP links identifies the four new types of packet used by the protocol: RTP PEP Start, RTP PEP Start Ack, RTP PEP Compress Data and RTP PEP Nak.

According to the protocol developed in accordance with the present invention, when a conversation is first identified, data is sent uncompressed with a RTP PEP Start header including static data fields. When a recipient router receives a RTP PEP start header for a new conversation, a conversation context is created, and the static data fields from the header of the uncompressed packet are saved. An RTP PEP start ack packet is returned. Once the RTP PEP start ack packet has been received by the router that originally identified the conversation, the RTP conversation data is sent over the tributary 24 in a compressed form following passing through compressor stage 36 (without the static header fields) and with an RTP PEP compressed data header, described in more detail below.

The pseudo-code for RTPCompressPacket (compress stage 36 of FIG. 3) is:

```
If new conversation
{
  Store static data
  Send uncompressed with RTP PEP Start header
}
Else if conversation is not yet ACKed
{
  Send uncompressed with RTP PEP Start header
}
Else
{
  Send compressed with RTP PEP compressed data header
}
```

Should compressed data be received with an unknown conversation identifier, an RTP PEP NAK packet is sent back which should cause the originator to identify the conversation again.

Additionally, before RTP data is sent across the tributary link 24, a local 16-bit timestamp is prepended to the RTP data payload (between the header and data) if optional jitter buffering is enabled.

As shown in FIG. 6B when a packet with an RTP header is received from a tributary 24, RTP PEP stage 50 (at step 64) applies the following logic:

```
If RTP Start packet
{
  Store static data
  Send RTP Start Ack packet
}
If RTP Start Ack Packet
{
  Mark conversation as known
}
If RTP compressed data packet [Decompress stage 52]
{
  Decompress data with static info stored for this conversation
}
If RTPJitterBuffer configured [Jitter Buffer stage 54]
{
  Strip timestamp;
  Push data into jitter buffer
}
Else
{
  Push packet into standard IP routing process [step 65]
}
```

If the packet is pushed into the jitter buffer, it is processed via the standard IP routing process at step 65 when it emerges from the jitter buffer.

The individual filter, compression and time-stamping schemes will now be described in more detail:

SIP Filter Stage 32

The SIP SDP 64 kbit/s codec filtering logic (see 32 of FIG. 3) searches for SDP within SIP signalling messages and strips out any PCMU and PCMA (G7111 64 k codec) negotiation and their associated RTPMAP entries from these messages—this should prevent SIP devices selecting 64 k codecs to use over the network. The RTPMAP is part of the RFC2327 Session Description Protocol and describes how a media format maps to RTP payload types.

For this SIP filtering to take place, the SIP signalling stream should be executing in a non-secured format over User Datagram Protocol (UDP). Preferably, SDP messages should be in the ASCII format.

Codec Filter Stage 34

When a G729B codec sends data over an RTP stream it typically generates 20 ms samples of 20 bytes (plus RTP/UDP/IP overhead). As previously described, during “normal” conversations, it can be seen that some G729B devices generate smaller samples (of 10 ms) as voice/silence transitions occur. There can be several of these per second even during, for example, “normal” speech. If these voice samples are not forwarded across the network, the perceived voice quality is not greatly affected and the bandwidth required to forward these packets is saved. These packets are silence information descriptors and are typically used for comfort noise generation. They may therefore be discarded (see 34 of FIG. 3) without creating an unacceptable perceived drop in voice quality.

Compress Stage 36, Decompress Stage 52

Previously when RTP traffic was carried across a network, each RTP packet was sent between the IP tributaries as a complete IP/UDP/RTP packet. The format of this packet is:

TABLE 2

| 2 bytes | 20 bytes | 8 bytes | 12 bytes | N bytes |
|---|---|---|---|---|
| IPTrib | IP Header | UDP | RTP Header | RTP |
| Header | | Header | | Payload |

Note that the multiplexer header and possible aggregate headers are still prepended to this data before transmission across the network.

By making assumptions about the contents of portions of the IP, UDP & RTP headers remaining constant throughout an RTP session (conversations), the router may be configured to search for these conversations occurring, inform the IP tributary peer of the contents of the headers, and then avoid sending the constant portions of the headers with each packet—instead just sending a conversation identifier. When the compressed packet arrives at the target IP tributary, the headers are reconstituted and sent on to the ultimate RTP target (for example LAN 11) and the RTP sequence and timestamp information is forwarded intact.

With the identified static data removed from the header (compress stage 36 of FIG. 3), the compressed data sent between the IP tributaries is:

TABLE 3

| 2 bytes | 8 bytes | N bytes |
|---|---|---|
| IPTrib Header | Compressed RTP Header | RTP Payload |

Therefore each RTP packet appears on the aggregate 26 with 32 fewer bytes. For G729k packets, this represents a saving of 52%. In uncompressed form, each 20 byte payload is sent between the tributaries as a 62 byte packet. In compressed form, each 20 byte payload is sent between the tributaries as a 30 byte packet.

When operating, the IP tributary code must look at each packet to be sent to the peer tributary to identify valid packets (IP & UDP checksums) and known conversations. Performance limitations may result. The code will consider any UDP traffic with an even port number (except the SIP port number 5060) as RTP traffic. Service management filters should be used to ensure that only RTP port numbers used in the target network are forwarding down an IP tributary 24 with the RTP compression enabled.

The feature must be turned on at both ends of an IP tributary 24 for the compression to work. If it is enabled on only one end, then all traffic is sent uncompressed and there is no benefit gained—this should be avoided as the performance overhead of looking for the conversations is still there. If the feature is enabled on one end of an IP tributary, but the peer is using older software that does not support the feature, then all RTP traffic will be discarded by the peer unit.

Timestamp Stage 38, Jitter Buffer Stage 54

Some SIP devices are not very tolerant of the large jitter seen in some IP networks, especially satellite networks. This jitter can be removed from an RTP stream that is forwarded through the embedded IP router 12 and across the network 14. When enabled, any RTP packets that are forwarded from the IP router 12 to an IP tributary 24 are pre-pended with a timestamp (16 bits) in their data payload. This timestamp is sent across the network with each RTP packet, and the timestamp can be used at the peer unit to forward packet onto the ultimate destination at the same frequency that the packets arrived at the original multiplexer.

Note that this scheme relies on creating timestamps from the clocks on peer routers across the network and using these to control packet synchronization—if these clocks themselves are not synchronized then over long conversations the jitter buffer may overrun or underrun. This could cause glitches in the delivered voice—however if silence suppression is used, then this is unlikely to occur.

As discussed above, a separate timestamp is used in addition to the RTP timestamp. This avoids the requirement of having knowledge about the format of the standard RTP timestamp which may change according to the type of data being carried across the RTP stream.

Note that the additional 16 bit timestamp overhead is not included in the packet formats and calculations in the RTP compression section. This additional overhead is only present when the jitter buffering is enabled, however, there is still an overall bandwidth saving even with the timestamps in use.

The techniques as described above may be executed on any appropriate hardware or in a software implementation.

These techniques are primarily described in relation to VoIP RTP traffic used for conversation transmission but can readily be used with any form of RTP traffic, for example, any form of media traffic. In particular, the format of the additional time stamp may be tailored for the needs of the data being transmitted.

The term conversation is used to identify a simplex RTP stream, that is to say any RTP packets in the reverse direction will be provided with their own separate compression establishment mechanism.

These techniques may also be applied to any appropriate type of network and for any type of conversation or other data session. Specifically, these techniques may be implemented to jitter-buffer any IP application, not just RTP streams. SIP filtering may also be performed for any codec type, not just G.711.

1. A method of transmitting data traffic from a first network node and receiving data traffic at a second network node comprising the steps of:
identifying a plurality of data packets as being members of a data session at the first network node;
adding a timestamp to the header or data payload of each packet within the data session wherein the timestamp is an additional timestamp;
transmitting the packets to a destination;
identifying the plurality of data packets as being members of the data session at the second network node;
extracting the additional timestamp from the header or data payload of each packet within the data session;
placing the packet in a jitter buffer for re-synchronising according to the additional timestamp; and
routing the packet to the destination.

2. The method of claim 1 further comprising the step of:
removing, at the first network node, requests for non-required codecs from the data packets of the data session.

3. The method of claim 1 further comprising the steps of:
identifying, at the first network node, packets containing silence; and
removing said packets from the data session;
wherein the data traffic is media data.

4. The method of claim 1 further comprising the step of:
removing, at the first network node, identified replicated data from the header of a packet within the data session.

5. (canceled)

6. The method of claim 4 further comprising the step of sending said replicated data in at least one initial uncompressed packet.

7. The method of claim 4 wherein the replicated data is static data.

8. (canceled)

9. The method of claim 4 further comprising the step of:
restoring, at the second network node, identified replicated data to the header of each packet within the data session.

10. (canceled)

11. The method of claim 9 further comprising the steps of receiving, at the second network node, at least one initial uncompressed packet containing the identified replicated data and applying said replicated data to subsequent packets in the same session.

12. The method of claim 1 wherein the data traffic comprises voice over internet protocol data traffic.

13. The method of claim 1 wherein the data session comprises an RTP conversation.

14. (canceled)

15. A system arranged to transmit data traffic comprising:
a network transmission node; and
a filtering stage arranged to:
identify a plurality of data packets as being members of a data session;
add a timestamp to the header or data payload of each packet within the session wherein the timestamp is an additional timestamp; and
transmit the packets to a destination node.

16. The system of claim 15 wherein
the filtering stage is further arranged to:
remove requests for non-required codecs from the data packets of the data session.

17. The system of claim 15 wherein
the filtering stage is further arranged to:
remove redundant packets from the data session;
wherein the data traffic is media data and the redundant packets contain silence.

18. The system of claim 15 wherein
the filtering stage is further arranged to:
remove identified replicated data from the header of a packet within the data session.

19. (canceled)

20. The system of claim 18 further arranged to send any replicated data in at least one initial uncompressed packet.

21. The system of claim 18 wherein the replicated data is static data.

22. A system arranged to receive data traffic comprising:
a network destination node; and
a filtering stage arranged to:
identify a plurality of data packets as being members of a data session;
extract an added timestamp from the data header or payload of each packet within the data session; and
place the packet in a jitter buffer for re-synchronising according to the added timestamp; and
route the packets to a destination.

23. The system of claim 22 wherein
the filtering stage is further arranged to:
restore identified replicated data to the header of each packet within the data session.

24. (canceled)

25. The system of claim 23 further arranged to receive at least one initial uncompressed packet containing the identified replicated data and apply said replicated data to subsequent packets in the same session.

26. The system of claim 15 wherein the data traffic comprises voice over internet protocol data and/or control traffic.

27. The system of claim 15 wherein the data session comprises an RTP conversation and/or associated SIP signalling.

28-31. (canceled)
